(19) United States
(12) Patent Application Publication
(10) Pub. No.: US 2013/0232031 A1
(43) Pub. Date: Sep. 5, 2013

(54) Bargaining System to Induce Truthful Revelation of Reservation Prices

(71) Applicants: Steven J. Brams, New York, NY (US); Todd R. Kaplan, Pardes Hanna (IL); D. Marc Kilgour, Kitchener (CA)

(72) Inventors: Steven J. Brams, New York, NY (US); Todd R. Kaplan, Pardes Hanna (IL); D. Marc Kilgour, Kitchener (CA)

(21) Appl. No.: 13/765,603

(22) Filed: Feb. 12, 2013

Related U.S. Application Data
(60) Provisional application No. 61/597,894, filed on Feb. 13, 2012.

(51) Int. Cl. G06Q 30/06

(52) U.S. Cl. CPC G06Q 30/0609
USPC 705/26.35

(57) ABSTRACT

Systems and methods for facilitating agreement between a first party and a second party. Each party may provide a reservation price and an offer price. Overlap between the information provided by the parties is utilized to determine a settlement price.

### CROSS-REFERENCE TO RELATED APPLICATIONS

This application claims priority from U.S. Provisional Application 61/597,894 filed Feb. 13, 2012, and is incorporated herein by reference in its entirety.

### FIELD OF THE INVENTION

The proposed invention facilitates reaching an agreement in bargaining over the price of a good, service, or contract settlement. Most simply, the mechanism induces a Buyer and a Seller truthfully to reveal to a referee their reservation prices, or “bottom lines”; if they overlap (i.e., Buyer's offer is at least as great as Seller's asking price), the mechanism gives a settlement, with a certain probability, in the overlap interval. In place of Buyer and Seller, the parties could be an accident victim making a claim of an insurance company, a union leader negotiating salaries with management, etc., each of whom is trying to reach a financial settlement.

### BACKGROUND OF THE INVENTION

How to induce two bargainers to go to their bottom lines is an age-old problem. In general, bargainers have an incentive to exaggerate their demands—Buyer to offer less, and Seller to ask more, than their reservation prices, which are the settlement prices that would make each indifferent between an agreement and no agreement. There is a need for systems and methods to induce truthful revelation of reservation prices.

### SUMMARY OF THE INVENTION

One embodiment of the invention relates to systems and methods for facilitating agreement between a first party and a second party, with the instruction when executed by a hardware processor performing the following: receiving a first reservation price from a first party interface and a second reservation price from a second party interface; determining if there is a reservation price overlap interval between the first reservation price and the second reservation price; if there is no reservation price overlap interval, then providing a no-settlement indication to the first party interface and the second party interface to indicate that there is no settlement; if there is reservation price overlap interval, then: receiving a first offer from the first party interface and a second offer from the second party interface; determining if the first offer price is within the reservation price overlap interval; determining if the second offer price is within the reservation price overlap interval; where at least one of the first offer price and second offer price is within the reservation price overlap interval, providing a settlement value indication, wherein: if the first offer and second offer both fall in the overlap interval, then the settlement value indication is the average of the first offer and second offer to the first party interface and the second party interface indicating; if the first offer is in the overlap interval and the second offer is not, then the settlement value indication is equal to the first offer with a predetermined probability to the first party interface and the second party interface; if the second offer is in the overlap interval and the first offer is not, then the settlement value indication is equal to the second offer with a predetermined probability; and if both the first offer and the second offer fall outside the overlap interval, then providing the no-settlement indication.

In an alternative embodiment, the offers may be provided prior to the reservation price. In an alternative embodiment, the offers and the reservation price may be provided at the same time.

Additional features, advantages, and embodiments of the present disclosure may be set forth from consideration of the following detailed description, drawings, and claims. Moreover, it is to be understood that both the foregoing summary of the present disclosure and the following detailed description are exemplary and intended to provide further explanation without further limiting the scope of the present disclosure claimed.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1 is a flow chart depicting a method of inducing truthful revelation of reservation prices;

FIG. 2 illustrates offer strategies for one embodiment;

FIG. 3 illustrates conditions for a transactions in one embodiment;

FIG. 4 is a block diagram of a computer system in accordance with an illustrative implementation.

### DETAILED DESCRIPTION OF THE PREFERRED EMBODIMENTS

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

In one aspect, a new two-stage bargaining mechanism is provided. A first party and a second party may interact through a first party interface and a second party interface with a bargaining system. One embodiment of the bargaining mechanism proceeds in two stages:
Stage 1. The buyer and seller submit their reservation prices, B and S, to a referee. If these prices do not overlap (i.e., B<S), there is no settlement, and the procedure ends:

0______B______S______1

If B≧S, there is an overlap interval, [S,B], and the procedure goes to stage 2:

0______S______B______1

Stage 2. The buyer and seller submit their offers, b and s, to the referee, which can produce a settlement in three different ways:

(i) If both b and s fall in the overlap interval, whether they do not crisscross because s>b (first diagram) or do because b>s (second diagram), the settlement price is the mean m=(b+s)/2:

0______S______b______m______s______B______1

0______S______s______m______b______B______1
(ii) If only b is in the overlap interval, then the settlement price is b with probability ½:

0_____S______b______B______s_____1
(iii) If only s is in the overlap interval, then the settlement price is s with probability ½:

0______b______S______s______B______1

In both cases (ii) and (iii), there is no settlement with probability' , even though one party's offer is inside the overlap interval (the mean of the parties' offers, m, may or may not be inside). In addition, there is no settlement with certainty if both b and s fall outside the overlap interval, even though m may fall inside (not shown).

This mechanism renders it optimal for the parties to be truthful about their reservation prices, B and S, in stage 1, independent of their beliefs about the other party's reservation price. However, the parties' optimal offers, b and s, in stage 2 do depend on these beliefs (defined by a probability distribution over the other party's reservation price) and do not simply duplicate B and S.

In fact, because one or both of b and s are used in the settlement price, the bargainers have an obvious incentive to exaggerate them: The buyer will always choose b≦B, and the seller will always choose s≧S, as shown in Steven J. Brams, Todd R. Kaplan, and D. Marc Kilgour, “A Simple Bargaining Mechanism That Elicits Truthful Reservation Prices,” (Preprint, Department of Politics, New York University, 2012). Consequently, one or both of the parties' offers may fall outside the overlap interval.

If exactly one of b or s falls inside, then there will be a settlement only with probability ½, not certainty. This uncertainty, for which one inside offer is necessary but not sufficient to produce a settlement, helps to induce the bargainers to be truthful about B and S. Moreover, even when the mechanism fails to produce a settlement, it does reveal—if it continues to stage 2 because the reservation prices overlap—that these prices allow for a mutually profitable settlement.

In another form, the two stages can be viewed as follows where the Seller's reservation price for the object, S, as the value of a random variable with cumulative distribution function Fs and the Buyer's reservation price, B, is the value of a random variable with cumulative distribution function FB. Both FS and FB have support [C;D]. In this embodiment, both parties' reservation prices are private information, and their utilities are quasi-linear so that if a sale takes place at price p, Buyer will receive B-p and Seller will receive p-S. If there is no sale, both parties receive 0. The parties are risk-neutral.

The mechanism of this embodiment is a two-stage procedure:
Stage 1. The parties submit reserves to through the first party interface: Seller submits Ŝ and Buyer submits \hat{B}. The reserves may or may not equal the corresponding reservation prices (i.e., the 1st-stage submissions are not necessarily truthful). If Ŝ≦_\hat{B}, the overlap interval is [Ŝ, \hat{B}.], and the procedure moves to stage 2. If Ŝ>\hat{B}, the reserves do not overlap, there is no settlement, and the procedure ends.
Stage 2. The parties are told that they reach stage 2.6 The parties submit offers to the referee: Seller submits s≧Ŝ, and Buyer submits b≦\hat{B}.: If both s and b fall in the overlap interval defined in stage 1, there is a sale at price p=(s+b)/2. If only one of s and b falls in the overlap interval, the name of one party is selected at random; if the selected party's offer is the one in the overlap interval, then it is sale price; if not, there is no sale. If neither offer is in the overlap interval, there is no sale.

This mechanism determines (i) whether there is a sale and (ii) if there is a sale, at what price. Each party is modeled as privately learning its own (true) reservation price (S or B) prior to stage 1, and using this information to choose its strategy: (Ŝ; s) for Seller; (\hat{B}; b) for Buyer. Thus, a strategy for Seller is a pair of functions Ŝ (S) and s(S) that give the values of its strategic variables as a function of its reservation price. Similarly, Buyer's strategy can be thought of as two functions, \hat{B}̂ (B) and b(B). One strategy for a party weakly dominates another strategy for that party if the first yields an expected utility that is at least as great as the second, no matter what strategy is chosen by the opponent. A (Bayesian-Nash) equilibrium is a profile of strategies with the property that each party's equilibrium strategy maximizes the party's expected utility, given that the opponent plays according to its equilibrium strategy.

Two functions represent the mechanism:

t: R⁴→[0,1] and p: R⁴→R

with the interpretation that t(Ŝ; s; \hat{B}; b) is the probability that an agreement is reached if the 1st-stage reserves are Ŝ and \hat{B}, and the 2nd-stage offers are s and b; similarly, p(Ŝ; s; \hat{B}; b) is the price. Note that both Ŝ and s are functions of Seller's true reservation price S; with Ŝ used instead of Ŝ (S), and s instead of s(S), for notational simplicity. Observe that the value of p is irrelevant if t=0. Using the functions t and p, the mechanism formally may be described as follows:

$$( t , p ) = \{ \begin{matrix}( 1 , \frac{s + b}{2} ) & if \hat{S} \leq s , b \leq \hat{B} \\ ( \frac{1}{2} , b ) & if \hat{S} \leq b \leq \hat{B} < s , \\ ( \frac{1}{2} , s ) & if b \leq \hat{S} \leq s \leq \hat{B} , \\ ( 0 , 0 ) & otherwise\end{matrix} \qquad ( 1 )$$

A strategically equivalent mechanism can be constructed by retaining stage 1 and replacing stage 2 by with Stage 2′ wherein one party, Seller or Buyer, is chosen at random. If Seller is chosen, and if Seller's 2nd-stage offer s satisfies s≦\hat{B}, then the transaction takes place at price p=s; if s>, \hat{B}, then there is no sale. Similarly, if the party chosen is Buyer, and if Buyer's 2nd-stage offer b satisfies Ŝ≦b, then the transaction takes place at price p=b; if b<Ŝ, there is no transaction.

The random selection of a party in stage 2′ is independent of the parties' reservation prices. The equivalence of the two mechanisms arises because, if stage 2′ is followed, the parties' expected utilities are exactly as in (1). For example, if Ŝ≦s, b≦\hat{B}, then Seller's expected utility is

$$\frac{1}{2} ( s - S ) + \frac{1}{2} ( b - S ) = \frac{2 + b}{2} - S = p - S ,$$

where p is determined by the first condition of (1). A similar relation holds for Buyer. The verification is immediate if the 2nd-stage offer of only one party, or none, falls in the overlap interval. Below, the stage 2 and stage 2′ formulations are used interchangeably.

Finally, it is assume that the parties' reservation prices are independently distributed. Moreover, it is also assumed that their distributions, FS and FB, have identical support [C;D], are continuous and have strictly positive densities.

In one embodiment, the systems and methods utilize a mechanism where rational parties will be induced to be truthful about their reservations prices. In one implementation, truth-telling is defined as follows:

Definition 1 Seller's strategy (Ŝ; s) is truth-telling if Ŝ (S)=S for all S ∈ [C;D]. Buyer's strategy (\hat{B}; b) is truth-telling if \hat{B} (B)=B for all B ∈ [C;D]. A strategy profile (Ŝ; s; \hat{B}; b) is a truth-telling equilibrium if it is an equilibrium and both parties' strategies are truth-telling. Note that truth-telling refers to the parties' reserve strategies (1st stage), not their offer strategies (2nd stage) in the embodiment described below.

Buyer's monotone hazard rate condition is satisfied if and only if Buyer's cumulative distribution function, F_{B} (x), satisfies

$$\frac{d}{d x} \frac{{F}_{B}^{′} ( x )}{1 - {F}_{B} ( x )} \geq 0$$

### for all x ∈ [C,D].

Similarly, Seller's monotone hazard rate condition is satisfied iff Seller's cumulative distribution function, F_{S}(x), satisfies

$$\frac{d}{d x} \frac{{F}_{S}^{′} ( x )}{{F}_{S} ( x )} \geq 0$$

for ∈ [C,D], If both Buyer's and Seller's monotone hazard rate conditions are satisfied, the procedure has a unique truth-telling equilibrium, as shown next.

Proposition 1 Truth-telling is a weakly dominant strategy for both Buyer and Seller and the parties' 2nd-stage offers, s* and b*, are solutions of 1−F_{B}(s)=(s−S)F_{B}′(s) and F_{S}(b)=(B−b)F_{S}′(b), respectively. Moreover, if F_{S}(·)and F_{B}(·) satisfy monotone hazard rate conditions, then the solutions s* and b* are unique, and the only truth-telling equilibrium is (S,s*; B,b*).

Proof. Seller knows the value of S and determines strategy (s; Ŝ) using the functions s(S) and Ŝ (S). Seller's expected utility is taken with respect to Buyer's value, B and the random choice of Seller or Buyer. Therefore, Seller's expected utility given S (calculated according to the procedure of stage 2′) is

½E[I_{b(B)≧Ŝ}·(b(B)−S)]+½E[I_{\hat{B}(B)≧s}·(s−S)] (2)

where IC is an indicator function that takes the value of 1 or 0 according to whether condition C is true or false. The first expression is associated with the random selection of Buyer (so the price is b) and the second with the selection of Seller (so the price is s). Note that Ŝ only appears in the expected utility as part of the indicator function in the first expression. Also, note that the first expression is maximized when the indicator function is 1 whenever b(B)−S>0 and is 0 otherwise. This is achieved by setting Ŝ equal to S. This is truthtelling and is true for any b(B). Hence, it is weakly dominant to tell the truth. Likewise, one can show the same for truthtelling of Buyer.

From (1), if there is a positive probability of trade, then s S and b≦\hat{B}. Next, consider stage 2′, and suppose that Seller is chosen. Then the two strategy functions s(S) and \hat{B} (B) can be proven to differentiable and strictly increasing, using method of Theorem 1 of Chatterjee and Samuelson. Similarly, assuming that Buyer is chosen leads to a proof that Ŝ (S) and b(B) are differentiable and strictly increasing. Therefore (2) can be rewritten as

½∫_{b}_{^{−1}}_{(Ŝ)}^{D}(b(B)−S)dF_{B}(B)+½∫_{b}_{^{−1}}_{(Ŝ)}^{D}(b(B)−S)dF_{B}(B)+½ (3)

Consider the information provided by (3) about Seller's choice of strategy functions. The first integral of (3) depends on Ŝ but not s, and the second integral of (3) depends on s but not Ŝ. Therefore, Seller maximizes its expected utility by choosing Ŝ to maximize the first integral and s to maximize the second.

Seller's choice of s to maximize the second integral of (3) must be considered. With the substitution \hat{B} (B)=B, this integral becomes

$$\begin{matrix}W ( s ) = \frac{1}{2} {\int }_{s}^{D} ( s - S ) d {F}_{B} ( B ) \\ = \frac{1}{2} ( s - S ) ( 1 - {F}_{B} ( s ) ) .\end{matrix}$$

Because S<D, the maximum of W(s) must be interior, as W(S)=W(D)=0 but

$$W ( \frac{S + D}{2} ) > 0.$$

Hence, the maximum must occur at a value of s that solves the first-order condition 1−F_{B}((s)=(s−S)F_{B}′(s) This equation always has at least one solution. Moreover, under the monotone hazard rate condition for Buyer, this solution is unique; denoted as s*(S). Buyer's optimal offer, and its relation to the monotone hazard rate condition for Seller, are analogous. In particular, if both monotone hazard rate conditions are satisfied, there is a unique truth-telling equilibrium, which is denoted as (S, s*;B; b*).

Proof that (S; s*;B; b*) is an equilibrium thus relies on the fact that strategies that are not truth-telling are weakly dominated by strategies that are, so there must be a truth-telling equilibrium. Then the offer strategies are obtained by maximizing the parties' expected utilities under the assumption of truth-telling. To understand why truth-telling dominates, note that each party benefits from maximizing the width of the overlap interval, up to its reservation price—Seller from below and Buyer from above—in order to ensure, insofar as possible, that the 2nd-stage bids, s and b, fall in the interval, thereby meeting a necessary condition for an agreement.

In fact, truthfully reporting one's reservation price in stage 1 is analogous to bidding one's reservation price in a Vickrey auction: Just as a party cannot win in a Vickrey auction without being the highest bidder, a bargainer cannot reach a settlement unless there is an overlap interval, leading to stage 2. In each case, a party goes to its bottom line for two reasons: (i) failing to do so in stage 1 could preclude a favorable outcome in stage 2 (or cause an unfavorable outcome) and (ii) once in stage 2, the outcome does not depend on what the party reported in stage 1.

A party's utility, if positive, does not depend on the reserves, Ŝ and \hat{B}, submitted in stage 1 but, instead, on its bid, s or b, submitted in stage 2. The independence between a party's reserve and its offer implies that it can “afford” to be truthful in stage 1. In fact, a party cannot do worse by reporting its reservation price truthfully in stage 1, and may do better, so under one embodiment of the mechanism each party has an incentive to report its reservation prices truthfully. The situation is different, however, in stage 2 as each party will have an incentive to shade its offer, depending on the distribution of the opponent's reservation price.

In one example, it is assumed C=0 and D=1, so that 0≦_S;B≦1.

### EXAMPLE1

### Uniform Distribution

F_{S}(x)=F_{L}(x)=x. The parties' optimal offers,

$${s}^{*} ( S ) = \frac{1 + S}{2} and {b}^{*} ( B ) = \frac{B}{2} , ,$$

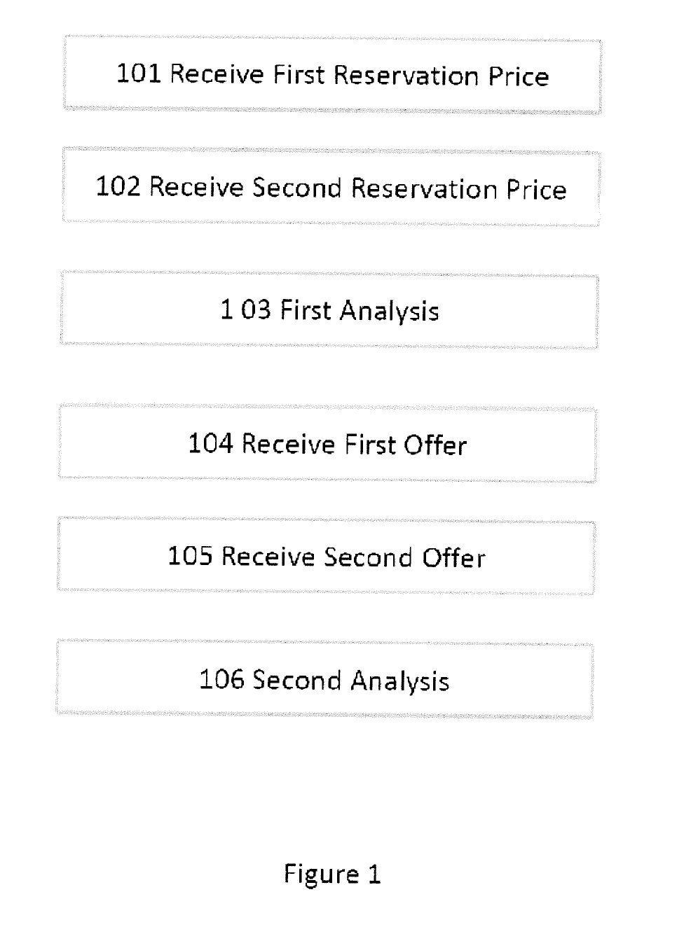

are shown in FIG. 1 below. Notice that each of these strategies halves the distance between the reservation prices, S and B (shown as the line S=B), and the endpoints, 1 and 0, respectively, of the bargaining range. In particular, Seller never offers below ½, and Buyer never offers above 1.

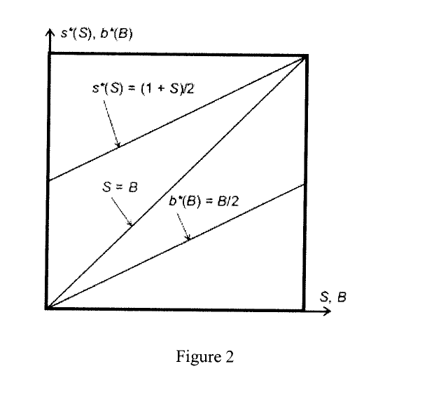

It is clear that truthfully reporting one's reservation price in the 1st stage is weakly but not strictly dominant. For example, if Seller's true value is 12 S=¾, then, as can be seen from FIG. 2, Seller's 2nd-stage bid will be s=s*(3 4)=⅞ at equilibrium. If B>⅞, there will be a sale with probability 1 2; otherwise, there is no possibility of a sale. Hence, in the 1st-stage, Seller will be indifferent between reporting 3 4 and, say, ⅝ (provided the 2nd-stage bid remains s=⅞).

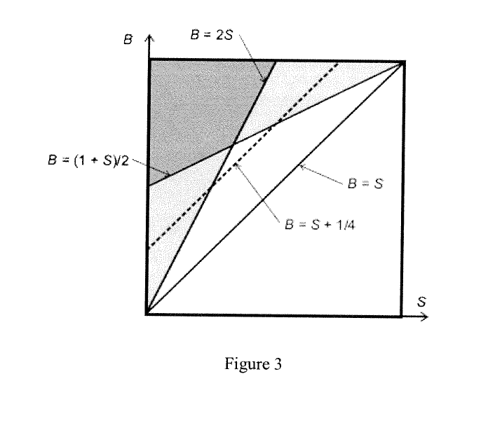

FIG. 3 graphs the results of the equilibrium strategies and identifies all possible values of S and B. A sale occurs with certainty when B<2S and B>(1+S)/2 ; these two conditions define the region with darker shading in FIG. 3. This region has small values of S and large values of B, with the difference between them so great that the offers, s*and b*, fall in the overlap interval.

A transaction occurs with probability ½ when 2S<B<(1+S)/2 and

$$\frac{1 + S}{2} < B < min \{ 2 S , 1 \} , ,$$

which are the two regions with lighter shading in FIG. 3. In the first of these regions (lower left), s*>B but b*>S, so there is a sale at p=b*when Buyer's name is drawn in stage 2′, and no sale otherwise. Similarly, in the upper right region, s*<B and b*<S, so there is a sale at p=s*when Seller's name is drawn in stage 2′, and no sale otherwise.

It is instructive to compare an embodiment of the mechanism with the Chatterjee-Samuelson mechanism (Chatterjee, K. and Samuelson, W. 1983, “Bargaining under incomplete information,” Operations Research, 31 (5), 835-851.) which produces a transaction, for certain, if and only if B≧S+¼. This inequality defines the area above the dashed line in FIG. 3. It is possible to compare mechanisms using the expected surplus they produce, which because the assumptions equal the total expected utility of Buyer and Seller after the transaction, if any. For an “ideal” procedure, which produces a settlement whenever the parties' reservation prices overlap, the total surplus is

∫₀¹ ∫_{B}¹(B−S)dSdB=⅙.

Myerson and Satterthwaite (Myerson, R. B. and Satterthwaite, M. A., 1983, “Efficient mechanisms for bilateral trading,” Journal of Economic Theory, 29 (2), 265-281.) demonstrated that no mechanism can produce a larger surplus than the Chatterjee-Samuelson mechanism, which gives

∫_{D}^{3/4} ∫_{S+1/4}¹(B−S)dBdS= 9/64.

The surplus from one embodiment of mechanism is

$$\frac{1}{2} {\int }_{0}^{1} {\int }_{\frac{1 + S}{2}}^{1} ( B - S ) d B d S + \frac{1}{2} {\int }_{0}^{\frac{1}{2}} {\int }_{2 S}^{1} ( B - S ) d B d S = \frac{1}{8} ,$$

which is 8/9=88:9% of the maximum possible surplus.

But there are other ways to compare mechanisms. One positive aspect of ours is the potential for trade at all possible values of S and all possible values of B, a feature that the Chatterjee-Samuelson mechanism does not share. For instance, if S=0.8 and B≧0.9, a sale occurs with probability 0.5 under an embodiment of the mechanism, but probability 0 under the Chatterjee-Samuelson mechanism.

### EXAMPLE 2

### Power Distribution

F_{S}(x)=x^{α}, F_{B}(x)=1−(1−x)^{β}, for α, β>0. It is easy to verify that these distributions satisfy the monotone hazard rate conditions. Buyer's optimal offer is

$${b}^{*} = \frac{α B}{1 + α}$$

### and Seller's is

$${s}^{*} = \frac{1 + β S}{1 + β} ,$$

in agreement with Example 1, which corresponds to α=β=1. For example, when α=β=2, b*(B)=⅔B and s*(S)=⅓+⅔S, and when α=β=½, b*(B)=⅓B and s*(S)=⅔+⅓S.

One aspect of the invention relates to an elegant 2-stage mechanism that induces two bargainers to be truthful in reporting their reservation prices in the 1* stage; if these prices criss-cross, the referee reports that there is an overlap interval, and the bargainers make offers in a 2nd stage. The mean of these offers becomes the settlement if they both fall in the overlap interval. If only one offer does, it becomes the settlement price, but it is implemented with probability ½; if it is not implemented, or if neither offer falls in the overlap interval, there is no settlement. Each party's equilibrium offer is linearly related to the opponent's distribution.

There are many mechanisms equivalent to, or related to, ours. For example, stage 1 and stage 2 could be simultaneous. Or they could be reversed. In he latter case, the 1st stage would be identical to the Chatterjee-Samuelson mechanism; if there is no trade, the 2nd stage would ask for reserves. Then a party would be chosen with probability ½; that party's offer would be the transaction price if it is within the opponent's reserve. There is also the possibility of combining embodiments of the mechanism with that of Chatterjee and Samuelson. The designer would collect the information (\hat{B}; b; Ŝ; s) and run the CS mechanism with probability α and the mechanism with probability 1−α For all α ∈ (0; 1), it would be weakly dominant to tell the truth, i.e., \hat{B}=B; Ŝ=S. Moreover, this scheme would approach CS in efficiency as α→1.

Embodiments of the mechanism are less efficient than the Chatterjee-Samuelson mechanism for uniformly distributed reservation prices, but it does have several features to recommend it, such as the possibility of a transaction even for an extreme reservation price. If the monotone hazard rate condition holds, there is a unique truth-telling equilibrium (and, even without this condition, it is almost always unique). Under embodiments of the mechanism, truth-telling in the 1^{st} stage is always optimal, but other behavior may produce the same results. However, for a party whose value falls within the range of 2nd-stage offers of the opponent, the equilibrium strategy of truth-telling is strictly optimal. Certain embodiments of mechanism admit a no-trade equilibrium (a trade occurs with probability zero) in addition to the truth-telling equilibrium, but this feature plagues any mechanism that satisfies individual rationality and balances the budget. Such an equilibrium would be unlikely to occur in practice when the alternative, truth-telling, has positive expected utility. In fact, in embodiments of the mechanism the designer would know that, if a trade occurred, there must have been truth-telling in stage 1. Moreover, any reserve that lies in the interior of the support of the opponent's reservation prices must be truthful.

Part of the inefficiency of embodiments of the mechanism stem from the random implementation of a 2nd-stage offer, s or b, as the exchange price when only one offer falls in the overlap interval. Randomizing the implementation of a single inside offer is the penalty one pays to render a party's reserve independent of its offer in the expected-payoff calculation, thereby making it optimal for the party to report truthfully its reservation price. This independence would be broken, and it would be suboptimal for a party truthfully to report its reservation price, if single inside offers were implemented with certainty. Brams and Kilgour (Brams, S. J. and Kilgour, D. M., 1996, “Bargaining procedures that induce honesty,” Group Decision and Negotiation, 5 (3), 239-262.)analyze other mechanisms that induce two bargainers to be truthful, including a “bonus procedure” in which a third party induces the bargainers to be truthful by paying them a bonus when their bids criss-cross. But it is their “penalty procedure” that is closest to the present mechanism in inducing truth-telling behavior.

Under it, the bargainers make simultaneous offers in a single stage, with the proviso that the probability of implementation of a settlement is a function of the degree of overlap, if any, of the bids: the greater the overlap, the higher this probability. This procedure yields a surplus of 1/12, which is 50% of the maximum possible, and falls far short of the 88.9% achieved by the present mechanism. Moreover, unlike the present mechanism, the parties never learn whether their failure to settle was because (i) their bids did not criss-cross (as in stage 1), or (ii) they did criss-cross but probabilistic implementation prevented a settlement. In principle, however, they could be told whether (i) or (ii) prevented a settlement; if (ii), they might be motivated to try again, but not using the same mechanism (see discussion below).

An advantage of the present mechanism is that the parties always learn if stage 2 is reached and, therefore, that there is an overlap interval and the potential for a mutually profitable settlement. While embodiments of the mechanism do not reveal the amount of regret—for example, how close the 2nd-stage offers are to the overlap interval, the values of Ŝ=S, \hat{B}=B; s, and b could be revealed by the system to the parties, making public the reason why implementation failed in the 2nd stage. The knowledge that the optimality of shading one's “bottom line” in stage 2 was all that prevented a settlement might motivate other bargainers in a similar situation to try to find an agreement by other means (e.g., face-to-face informal bargaining, mediation, etc.). Importantly, one embodiment, requires that the bargainers must assign probability 0 to the possibility that they could benefit from the procedure when it produces no agreement.

### Implementation

In one embodiment, a system for implementing the Two-Stage Procedure includes computer hardware and a computer program, to which the parties input, separately and independently, B and S. The mechanism then determines if B≧S in stage 1. If not, there is no settlement, and the procedure ends.

If there is overlap, the parties input, separately and independently, b and s. Provided that there is either double overlap (both b and s are in [S,B]) or single overlap (only one of b or s is in [S,B]), a price is determined according to the rules of stage 2.

It is worth noting that the mechanism could be initiated by just one party (say, the buyer), who would input B and then invite the seller to use the mechanism—using email or some other form of communication—to input S. If the seller agrees, the mechanism would proceed as already discussed. Further, in one embodiment a party may place its reserve bid in a system to indicate it is willing to discuss a bargained-for exchange, such as for the sale of a house. Purchasers may then utilize the system of the present invention to begin the bargaining process. The reverse could also be done with potential purchasers placing reserve bids on a house initially.

If the seller refuses, the buyer would be sent a confidential and dated statement, e.g., in the form of an affidavit, that he or she proposed B, which could then be used as evidence (e.g., in a judicial proceeding) that he or she made a good-faith offer to try to reach a settlement. It is believed that the willingness of one party to input his or her reservation price, and possibly use it later as evidence of his or her commitment to a settlement, might well induce the other party to follow suit and use the mechanism.

The order of stages 1 and 2 can be reversed without changing the incentive of the mechanism to induce the parties to be truthful about their reservation prices. In such an embodiment, in stage 1, the parties would submit their offers; in stage 2, they would submit their reservation prices. If the offers crisscross in stage 1 (b≧s), the referee would announce that there is a settlement price—the mean of the offers, m=(b+s)/2—and the procedure would end. If the offers do not overlap, each party would be asked in stage 2 to submit his or her reservation price without knowledge of the other party's stage 1 offer. The settlement, or lack thereof, would then be exactly the same as that in which the submission of the reservation prices precedes the submission of offers.

If the offers are made first (i.e., in stage 1), they can be thought of as “posted prices.” If the offers do not overlap at this stage, in stage 2 each party would have an incentive to be truthful about his or her reservation price to ensure, insofar as possible, that it overlaps the other party's offer (i.e., posted price), because a party's reservation price will not be the settlement—the overlapped offer (with probability ½) will be if there is single overlap, or the mean of the two offers will be if there is double overlap. Of course, if the initial offers crisscross in stage 1, there will also be double overlap in stage 2, which is why there is no need to proceed to stage 2.

Because the two stages can be reversed without changing the incentives of the parties to be truthful about their reservation prices, their order does not matter. Therefore, in one embodiment, the parties submit their offers and reservation prices simultaneously.

Practically speaking, however, the bargainers will probably prefer to proceed in stages. Whether they submit their (i) reservation prices first or (ii) their offers first, the rules allow for the procedure to terminate in stage 1 if either the reservation prices do not overlap in (i), or the offers do crisscross in (ii). Thereby, going in stages renders the mechanism simpler, possibly needing only one stage, without strategic consequences. Because it is not evident whether the parties will prefer (i) or (ii), in one implementation the parties may determine whether reservation prices or offers are provided first, unless, of course, they prefer the simultaneous submission of both their offers and reservation prices.

Assume that the parties choose (i), so they submit their reservation prices first. Then if stage 2 is reached, they know that there is an overlap interval and, therefore, that there is the potential for a mutually profitable settlement. If the mechanism fails to produce a settlement in stage 2, in one embodiment the parties are told why it failed—either because both parties' offers, b and s, were outside the overlap interval, or one offer was inside but it was not implemented, which occurs with probability ½ (which party's offer was inside may or may not be revealed).

If the mechanism fails in stage 2, the parties might still try to find a settlement by other means, such as informal bargaining, mediation, etc. However, for purposes of one embodiment of the invention, the parties must assign probability zero to the possibility that they could benefit further; otherwise, their incentive to be truthful in stage 1 will be compromised. Thus, for example, they might be told that the procedure cannot be used again for six months, or some other time period that signals that a settlement that they hoped for is “dead in the water” for a significant time—the implication being that they should take the procedure seriously when it is first tried.

But there is nothing in the mechanism, after it has been unsuccessfully tried, that prevents the parties from continuing to negotiate with each other—in effect, to transcend the limitations of the mechanism. That is, can they do anything to assuage their dissatisfaction, and possibly escape the failure of the mechanism in stage 2, when it is known that their reservation prices overlap?

As suggested earlier, the parties can be told whether the mechanism's failure in stage 2 was because both their offers were outside the overlap interval, or only one party's offer was inside and it was not selected with probability ½. If both offers were outside, there would appear to be not much more that can be done except exhort the parties to try harder next time—if there even is a next time (but see below for a possible resolution to even this unpromising scenario).

More promising, it seems, is the situation in which exactly one party's offer is inside. Then, if both parties are agreeable, there are two plausible ways in which their dispute can be resolved:
Make the inside offer the settlement with certainty.
Make the settlement the inside offer averaged with the other party's reservation price.

In either case, the settlement will be inside the overlap interval, with the latter more favorable to the party that made the inside offer.

Both “solutions,” of course, would alter the mechanism and, in particular, undermine the incentive of the parties to be truthful about their reservation prices. Hence, in one embodiment neither is appended to the mechanism in a possible stage 3 but, instead, it is suggested that if the mechanism fails in stage 2, the parties be asked whether either of the options to resolve their dispute, mentioned in above, would be acceptable to them.

Only if both parties agree would an option be used, which gives each party a veto on continuation. Presumably, the inside party would seek the latter solution and the outside party would push for the former (a compromise would be that the average of these two solutions be implemented).

After being told the settlement price, the parties may or may not be given the option of backing out of the settlement, which a party may want to do if the settlement price is very close to its reservation price. The option of backing out should make the parties more willing to try to “rescue” a settlement that is mutually profitable but which the mechanism failed to produce.

Now consider how a resolution might be achieved if both offers are outside the overlap interval in stage 2. The parties might be allowed to make new offers, in successive rounds, until at least one party's offer goes inside the interval. If both offers go inside on the same round, the average would be the settlement; otherwise, the settlement would be the single offer that goes inside first.

In making successive offers, an optimal strategy is not to inch very slowly toward the other party's reservation price, because the other party could “beat you to the punch” and go inside first—and still, on average, be quite close to your reservation price and far from its own. While the idea of making successively better offers to try to converge on a settlement is the way real-life bargaining often occurs, it does not always get the bargainers to a settlement. By contrast, the aforementioned extensions of the Two-Stage Procedure, which would require both parties' acceptance to be implemented, would do just that.

Because, as noted earlier, these “fixes” to a failure in stage 2 force a settlement, they will, if implemented, affect how truthful the parties will be in reporting their reservation prices. Accordingly, in one embodiment, such “add-ons” to the mechanism are not utilized but, instead, may be separate procedures that both parties can, if they wish, decide to use if they fail to reach a settlement in stage 2.

But, if these fixes are anticipated, they alter the parties' incentives to be truthful, knowing that they might have the possibility of escaping the failure of the mechanism. Thus, the theoretical conditions that induce the parties to be truthful might, in practice, be renegotiated, especially if the parties are desperate for a settlement that they know, from the overlap of their reservation prices in stage 1, is within their grasp.

In one embodiment, the first party is a seller and the second party is a buyer. In an alternative embodiment, the first party is a making a claim against an insurance party and the second party is an insurance provider. In an alternative embodiment, the first party is an employee or union and the second party is an employer.

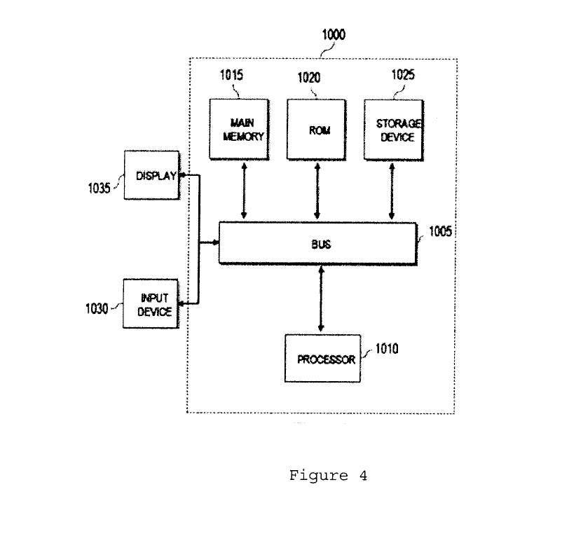

FIG. 4 is a block diagram of a computer system in accordance with an illustrative implementation. The computer system or computing device 1000 can be used to implement a device that includes the processor 106 and the display 108, the gaze capture component 104, etc. The computing system 1000 includes a bus 1005 or other communication component for communicating information and a processor 1010 or processing circuit coupled to the bus 1005 for processing information. The computing system 1000 can also include one or more processors 1010 or processing circuits coupled to the bus for processing information. The computing system 1000 also includes main memory 1015, such as a random access memory (RAM) or other dynamic storage device, coupled to the bus 1005 for storing information, and instructions to be executed by the processor 1010. Main memory 1015 can also be used for storing position information, temporary variables, or other intermediate information during execution of instructions by the processor 1010. The computing system 1000 may further include a read only memory (ROM) 1010 or other static storage device coupled to the bus 1005 for storing static information and instructions for the processor 1010. A storage device 1025, such as a solid state device, magnetic disk or optical disk, is coupled to the bus 1005 for persistently storing information and instructions.

The computing system 1000 may be coupled via the bus 1005 to a display 1035, such as a liquid crystal display, or active matrix display, for displaying information to a user. An input device 1030, such as a keyboard including alphanumeric and other keys, may be coupled to the bus 1005 for communicating information and command selections to the processor 1010. In another implementation, the input device 1030 has a touch screen display 1035. The input device 1030 can include a cursor control, such as a mouse, a trackball, or cursor direction keys, for communicating direction information and command selections to the processor 1010 and for controlling cursor movement on the display 1035.

According to various implementations, the processes described herein can be implemented by the computing system 1000 in response to the processor 1010 executing an arrangement of instructions contained in main memory 1015. Such instructions can be read into main memory 1015 from another computer-readable medium, such as the storage device 1025. Execution of the arrangement of instructions contained in main memory 1015 causes the computing system 1000 to perform the illustrative processes described herein. One or more processors in a multi-processing arrangement may also be employed to execute the instructions contained in main memory 1015. In alternative implementations, hard-wired circuitry may be used in place of or in combination with software instructions to effect illustrative implementations. Thus, implementations are not limited to any specific combination of hardware circuitry and software.

Although an example computing system has been described in FIG. 10, implementations of the observer matter and the functional operations described in this specification can be implemented in other types of digital electronic circuitry, or in computer software, firmware, or hardware, including the structures disclosed in this specification and their structural equivalents, or in combinations of one or more of them.

Implementations of the observer matter and the operations described in this specification can be implemented in digital electronic circuitry, or in computer software, firmware, or hardware, including the structures disclosed in this specification and their structural equivalents, or in combinations of one or more of them. The observer matter described in this specification can be implemented as one or more computer programs, i.e., one or more modules of computer program instructions, encoded on one or more computer storage media for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). Accordingly, the computer storage medium is both tangible and non-transitory.

The operations described in this specification can be performed by a data processing apparatus on data stored on one or more computer-readable storage devices or received from other sources.

[00771 The term “data processing apparatus” or “computing device” encompasses all kinds of apparatus, devices, and machines for processing data, including by way of example a programmable processor, a computer, a system on a chip, or multiple ones, or combinations of the foregoing. The apparatus can include special-purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing, and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video party, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special-purpose logic circuitry.

To provide for interaction with a user, implementations of the observer matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated in a single software product or packaged into multiple software products.

Thus, particular implementations of the observer matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A non-transitory computer-readable medium having instructions stored thereon for facilitating agreement between a first party and a second party, with the instruction when executed by a hardware processor performing the following:
receiving a first reservation price from a first party interface and a second reservation price from a second party interface;
determining if there is a reservation price overlap interval between the first reservation price and the second reservation price;
if there is no reservation price overlap interval, then providing a no-settlement indication to the first party interface and the second party interface to indicate that there is no settlement;
if there is reservation price overlap interval, then:
receiving a first offer from the first party interface and a second offer from the second party interface;
determining if the first offer price is within the reservation price overlap interval;
determining if the second offer price is within the reservation price overlap interval;
where at least one of the first offer price and second offer price is within the reservation price overlap interval, providing a settlement value indication, wherein:
if the first offer and second offer both fall in the overlap interval, then the settlement value indication is the average of the first offer and second offer to the first party interface and the second party interface indicating;
if the first offer is in the overlap interval and the second offer is not, then the settlement value indication is equal to the first offer with a predetermined probability to the first party interface and the second party interface;
if the second offer is in the overlap interval and the first offer is not, then the settlement value indication is equal to the second offer with a predetermined probability;
and
if both the first offer and the second offer fall outside the overlap interval, then providing the no-settlement indication.

2. The system of claim 1, wherein the predetermined probability is ½.

3. The non-transitory computer-readable medium of claim 1, wherein the predetermined probability is 1.

4. The non-transitory computer-readable medium of claim 1 wherein, if there is an overlap interval, then this is transmitted to at least one of the first party interface and the second party interface.

5. The non-transitory computer-readable medium of claim 1, wherein the hardware processor performs the following step: transmitting an invitation from one of the first party interface and the second party interface to the other of the first party interface and the second party interface to participate in bargaining.

6. The non-transitory computer-readable medium of claim 8 wherein, if an invited party declines to participate in the bargaining, then transmitting to the corresponding first party interface or second party interface documentation of the reservation price submitted and declination to participate.

7. The non-transitory computer-readable medium of claim 1 wherein:
if a no settlement indication is provided, then requesting a first party offer and a second party offer until at least one of a new first party offer and a new second party offer falls inside the overlap interface;
providing an settlement value indication:
if only one of the first party offer and the second party offer are within the overlap interval, equal to the offer within the overlap interval; and
if both the first party offer and the second party offer are within the overlap interval, equal to the average of the first party offer and the second party offer.

8. The non-transitory computer-readable medium of claim 1 wherein, if both the first offer and the second offer fall outside the overlap interval, then transmitting to the first party interface and the second party interface an indication of such.

9. The non-transitory computer-readable medium of claim 1 wherein, if one party's offer is inside the overlap interval, and one party's offer is outside of the overlap interval, then at least one of the parties is notified of such.

10. A non-transitory computer-readable medium having instructions stored thereon for facilitating agreement between a first party and a second party, with the instruction when executed by a hardware processor performing the following:
receiving a first-offer price from a first party interface and a second-offer price from a second party interface;
determining if the second-offer price is greater than or equal to the first-offer price, in which case a settlement-value indication is provided equal to the average of the first-offer price and the second-offer price; otherwise, receiving a first reservation price from the first party interface and a second reservation price from the second party interface;
determining if there is an overlap interval between the first reservation price and the second reservation price;
if there is no overlap interval, then providing a no settlement indication to the first user interface and the second user interface; otherwise,
if the first offer and second offer both fall inside the overlap interval, then providing to the first user interface and the second user interface a settlement value that is the average of the first offer and second offer; otherwise,
if the first offer is in the overlap interval and the second offer is not, then providing to the first user interface and the second user interface a settlement value that is the equal to the first offer with a predetermined probability; otherwise,
if the second offer is in the overlap interval and the first offer is not, then providing to the first user interface and the second user interface a settlement value that is the equal to the second offer with a predetermined probability; otherwise,
if both the first offer and the second offer fall outside the overlap interval, providing the no-settlement indication to the first user interface and the second user interface.

11. The non-transitory computer-readable medium of claim 10, wherein the predetermined probability is ½.

12. The non-transitory computer-readable medium of claim 10, wherein the predetermined probability is 1.

13. The non-transitory computer-readable medium of claim 10 wherein, if there is an overlap interval, then this is transmitted to at least one of the first party interface and the second party interface.

14. The non-transitory computer-readable medium of claim 10, wherein the hardware processor performs the following step: transmitting an invitation from one of the first party interface and the second party interface to the other of the first party interface and the second party interface to participate in bargaining.

15. The non-transitory computer-readable medium of claim 14 wherein, if an invited party declines to participate in the bargaining, then transmitting to the corresponding first party interface or second party interface documentation of the reservation price submitted and declination to participate.

16. The non-transitory computer-readable medium of claim 10 wherein if a no settlement indication is provided, then requesting a first party offer and a second party offer until at least one of a new first party offer and a new second party offer falls inside the overlap interface;
providing an settlement value indication:
if only one of the first party offer and the second party offer are within the overlap interval, equal to the offer within the overlap interval; and
if both the first party offer and the second party offer are within the overlap interval, equal to the average of the first party offer and the second party offer.

17. The non-transitory computer-readable medium of claim 10 wherein, if both the first offer and the second offer fall outside the overlap interval, then transmitting to the first party interface and the second party interface an indication of such.

18. The non-transitory computer-readable medium of claim 10 wherein, if one party's offer is inside the overlap interval, and one party's offer is outside of the overlap interval, then at least one of the parties is notified of such.

19. The non-transitory computer-readable medium of claim 10, further comprising the hardware processor performing the following steps: wherein the first-offer price and the first reservation price from the first party interface, the second offer price and the second reservation price from the second party interface are received prior to the determining if the second offer price is greater than or equal to the first offer price and the determining if there is the overlap interval.

20. A computer-implemented machine for facilitating agreement between a first party and a second party, comprising:
a processor; and
a tangible computer-readable medium operatively connected to the processor and including computer code configured to:
receive a first reservation price from the first party and a second reservation price from the second party;
determine if there is an overlap interval between the first reservation price and the second reservation price;
if there is no overlap interval, then indicate that there is no settlement; otherwise,
if the first offer and second offer both fall in the overlap interval, then indicate a settlement value which is the average of the first offer and second offer; otherwise,
if the first offer is in the overlap interval and the second offer is not, then indicate a settlement value equal to the first offer with a predetermined probability; otherwise,
if the second offer is in the overlap interval and the first offer is not, then indicate a settlement value equal to the second offer with a predetermined probability; otherwise,
if both the first offer and the second offer fall outside the overlap interval, then indicate no settlement.

21. A computer-implemented machine for facilitating agreement between a first party and a second party, comprising:
a processor; and
a tangible computer-readable medium operatively connected to the processor and including computer code configured to:
(1) receiving a first-offer price from a first party and a second-offer price from a second party;
(2) determining if the second-offer price is greater than or equal to the first-offer price, in which case the system indicates a settlement value equal to the average of the first-offer price and the second-offer price; otherwise, the system receives a first reservation price from the first party and a second reservation price from the second party;
(3) determining if there is an overlap interval between the first reservation price and the second reservation price;
(4) if there is no overlap interval, then indicating that there is no settlement; otherwise,
(5) if the first offer and second offer both fall inside the overlap interval, then indicating a settlement value which is the average of the first offer and second offer; otherwise,
(6) if the first offer is in the overlap interval and the second offer is not, then indicating a settlement value equal to the first offer with a predetermined probability; otherwise,
(7) if the second offer is in the overlap interval and the first offer is not, then indicating a settlement value equal to the second offer with a predetermined probability; otherwise,
(8) if both the first offer and the second offer fall outside the overlap interval, then indicating no settlement.

22. A method implemented on a hardware processor configured to perform the steps of:
receiving a first reservation price from the first party and a second reservation price from the second party;
determining if there is an overlap interval between the first reservation price and the second reservation price;
if there is no overlap interval, then indicating that there is no settlement; otherwise,
if the first offer and second offer both fall in the overlap interval, then indicating a settlement value which is the average of the first offer and second offer; otherwise,
if the first offer is in the overlap interval and the second offer is not, then indicating a settlement value equal to the first offer with a predetermined probability; otherwise,
if the second offer is in the overlap interval and the first offer is not, then indicating a settlement value equal to the second offer with a predetermined probability; otherwise,
if both the first offer and the second offer fall outside the overlap interval, then indicating no settlement.

23. A method implemented on a hardware processor configure to perform the steps of:
receiving a first-offer price from a first party and a second-offer price from a second party;
determining if the second-offer price is greater than or equal to the first-offer price, in which case the system indicates a settlement value equal to the average of the first-offer price and the second-offer price; otherwise, the system receives a first reservation price from the first party and a second reservation price from the second party;
determining if there is an overlap interval between the first reservation price and the second reservation price;
if there is no overlap interval, then indicating that there is no settlement; otherwise,
if the first offer and second offer both fall inside the overlap interval, then indicating a settlement value which is the average of the first offer and second offer; otherwise,
if the first offer is in the overlap interval and the second offer is not, then indicating a settlement value equal to the first offer with a predetermined probability; otherwise,
if the second offer is in the overlap interval and the first offer is not, then indicating a settlement value equal to the second offer with a predetermined probability; otherwise,
if both the first offer and the second offer fall outside the overlap interval, then indicating no settlement.
